(19) United States
(12) Patent Application Publication
(10) Pub. No.: US 2007/0040016 A1
(43) Pub. Date: Feb. 22, 2007

(54) System and method for completing a transaction

(76) Inventors: Bradley Snower, Chicago, IL (US); Christopher Primbas, Chicago, IL (US)

Correspondence Address: PATENTS+TMS;A Professional Corporation, 2849 W. Armitage Ave., Chicago, IL, 60647, US

(21) Appl. No.: 11/204,515

(22) Filed: Aug. 16, 2005

(51) Int. Cl. G06K 5/00; G06Q 40/00

(52) U.S. Cl. 235/380; 705/39

(57) ABSTRACT

A method and a system complete a transaction with an identification card and/or a point of sale system. A customer tenders an amount of money to a retailer for purchasing a product and/or a service offered by the retailer and/or for completing a retail transaction with the retailer. The retailer may owe a monetary value to the customer from the retail transaction. A financial account associated with the identification card of the customer is identified by the point of sale system. The point of sale system and/or the retailer transfers the monetary value to the financial account associated with the identification card of the customer. The identification card is associated with a balance of the financial account. The balance of the financial account is redeemable with the retailer to complete an additional retail transaction. The point of sale system transmits information relating to the identification card and/or relating to the financial account to a server via a network. The server stores information in a database which is connected to the server. The customer and/or the retailer access the information stored in the database via a website, the point of sale system and/or the network.

### BACKGROUND OF THE INVENTION

The present invention generally relates to a system and a method for completing a transaction. More specifically, the present invention generally relates to a system and a method for completing a transaction with an identification card and/or a point of sale (hereinafter “POS”) system. A customer may transfer and/or may tender an amount of money to a retailer for purchasing a product and/or a service offered for sale by the retailer and/or for completing a retail transaction with the retailer. The value of the product and/or the service may be less than the amount of money transferred to the retailer. As a result, the retailer may owe a value of change to the customer from the retail transaction.

A financial account associated with the identification card of the customer may be identified by the POS system. The POS system may transfer the value of the change to the financial account associated with the identification card of the customer. As a result, the identification card may have a monetary value to be redeemed with the retailer to complete a retail transaction. The POS system may transmit information relating to the identification card and/or relating to the financial account to a server via a network. The server may store information in a database which may be connected to the server. The customer and/or the retailer may access the information stored in the database via a website and/or the network.

It is, of course, generally known that a monetary value of the change owed to a customer by a retailer is directly distributed to the customer from a cash register of the first retailer. As a result, the customer may receive the change from the first retailer which may be inconvenient to the customer. Additionally, the customer must find a storage location for storing the change prior to exiting the establishment of the first retailer. However, the customer may not have a storage location which may be available and/or may be convenient for storing the change. As a result, the customer may delay the first retailer from attending to other customers while accessing the storage location. Moreover, the customer may lose and/or may misplace the change prior to placing the change in the storage location.

Known methods of converting change of a monetary value to a financial account associated with a plastic card generally involve the customer manually feeding the change into a counting apparatus which counts and/or which organizes the change. As a result, the counting apparatus calculates the monetary value of the change. The customer inserts the plastic card into a receiving unit on the counting apparatus for identification the plastic card. The counting apparatus reads a magnetic swipe of the plastic card to identify a financial account and/or to identify the first retailer associated with the plastic card.

The customer presses a button located on the counting apparatus to transfer the monetary value of the change to the financial account associated with the plastic card. The counting apparatus transfers the monetary value of the change to the financial account associated with the plastic card. As a result, a balance equal to the monetary value of the change is assigned to, is transferred to and/or is added to the financial account associated with the plastic card.

The counting apparatus may transmit information relating to the plastic card and/or the balance of the plastic card to a computer. The computer may store the information in a database via a network. The customer may utilize the balance to purchase products and/or services from a first retailer associated with the card. Further, the user may add a monetary value to the balance of the financial account associated with the plastic card via the counting apparatus. However, the customer may not utilize the balance to purchase products from a second retailer. Additionally, the customer may difficulty with and/or may be inconvenienced by feeding the change into the counting apparatus. Further, the customer may lose or may misplace the change prior to feeding the change into the counting apparatus. Still further, the customer may lose or may misplace the plastic card prior to inserting the plastic card into the receiving unit of the counting apparatus. Moreover, the counting apparatus may be incapable of reading the magnetic swipe strip of the plastic card. Furthermore, the counting apparatus may fail to transmit the information relating to the balance of the card to the computer.

A need, therefore, exists for a system and a method for completing a transaction which may utilize an identification card and/or a POS system. Further, a need exists for a system and a method for completing a transaction which may transfer a value of change to the identification card without distributing the change to a customer. Still further, a need exists for a system and a method for completing a transaction which may permit a first balance and a second balance associated with the identification card to be redeemable with a first retailer and a second retailer, respectively. Moreover, a need exists for a system and a method for completing a transaction which may prevent loss of the change prior to transferring a value of the change to a financial account associated with the identification card.

### SUMMARY OF THE INVENTION

The present invention generally relates to a system and a method for completing a transaction. The system and the method may have one or more point of sale (hereinafter “POS”) systems which may be utilized by one or more retailers to conduct and/or to complete one or more retail transactions. The system and the method may have an identification (hereinafter “ID”) card which may allow one or more retailers to transfer a value of change received from one or more retail transactions to a financial account associated with the ID card via the POS systems. A balance of the financial account may be utilized by a customer to complete retail transactions with the one or more of the retailers. The system and the method may have a server with a database which may be connected to and/or may be in communication with one or more POS systems via a network. One or more retailers and/or a customer may access information relating to the balance, the financial account and/or the ID card in the database via a website and/or the network.

To this end, in an embodiment of the present invention, a system for completing a transaction between a customer and a first retailer wherein the transaction has a first monetary value is provided. The system has an identification card assigned to the customer wherein an amount of money is tendered to the first retailer by the customer wherein the amount of money is greater than the first monetary value. Further, the system has a first financial account associated with the identification card wherein the first financial account has a balance of a second monetary value. Still further, the system has a database for storing information based on the balance of the first financial account. Moreover, the system has a server connected to the database wherein the server accesses the balance of the first financial account and further wherein the server stores the information based on the balance of the first financial account in the database. Furthermore, the system has a first point of sale system remotely connected to the server via a network wherein the first point of sale system is local with respect to the customer wherein the identification card is identified by the first point of sale system wherein the first point of sale system accesses the information stored in the database to determine the balance of the first financial account wherein the first point of sale system electronically transfers a third monetary value to the balance of the first financial account via the network and further wherein the third monetary value is a difference between the amount of money and the first monetary value.

In an embodiment, the system has a code associated with the first retailer.

In an embodiment, the system has a code associated with the identification card.

In an embodiment, the system has a second financial account associated with the identification card.

In an embodiment, a second retailer associated with the identification card.

In an embodiment, the system has a second point of sale system accesses the information in the database via the network.

In an embodiment, the balance of the first financial account is zero.

In an embodiment, the balance of the first financial account is redeemable with the first retailer via the first point of sale system.

In another embodiment of the present invention, a method for completing a transaction of a first monetary value between a customer and a retailer wherein the customer tenders an amount of money to the retailer for completing the transaction wherein the amount of money is greater than the first monetary value is provided. The method has the step of providing an identification card to the customer wherein the identification card is associated with a financial account having a balance of a second monetary value. Further, the method has the step of storing information in a database wherein the information is based on the balance of the financial account wherein the database is remote with respect to the customer. Still further, the method has the step of providing a point of sale system of the retailer wherein the point of sale system is connected to the database via a network wherein the point of sale system is remote with respect to the database. Moreover, the method has the step of electronically accessing the information in the database via a point of sale system of the retailer wherein the point of sale system determines the balance of the financial account via the information stored in the database. Furthermore, the method has the step of electronically transferring a third monetary value to the balance of the financial account via the point of sale system and the network wherein the third monetary value is a difference between the amount of money and the first monetary value.

In an embodiment, the method has the step of printing a receipt displaying the first monetary value, the second monetary value, the third monetary value, the amount of money or the balance of the financial account.

In an embodiment, the method has the step of providing a website for displaying the information stored in the database.

In an embodiment, the balance of the financial account is zero.

In an embodiment, the method has the step of assigning an identification code to the retailer, the customer or the identification card.

In another embodiment of the present invention, a method for completing a transaction of a first monetary value between a first retailer and a customer wherein the customer tenders an amount of money to the first retailer wherein the amount of money is greater than the first monetary value is provided. The method has the step of providing an identification card to the customer wherein the identification card is associated with a first financial account wherein the first financial account has a balance of a second monetary value wherein the first financial account is associated with the first retailer. Further, the method has the steps of storing information in a database wherein the information is based on the balance of the first financial account and providing a server for accessing the information stored in the database wherein the server is connected to the database via a network. Still further, the method has the step of identifying the first financial account with a point of sale system of the first retailer wherein the point of sale system is connected to the server via the network wherein the point of sale system is remote with respect to the server and further wherein the point of sale system determines the balance of the first financial account from the information stored in the database. Moreover, the method has the step of electronically transferring a third monetary value to the balance of the first financial account via the point of sale system wherein the third monetary value is a difference between the first monetary value and the amount of money.

In an embodiment, the balance of the first financial account is zero.

In an embodiment, the method has the step of accessing a second financial account associated with the identification card.

In an embodiment, the method has the step of assigning an identification code to the first retailer, the customer or the identification card.

In an embodiment, the method has the step of redeeming the balance of the first financial account with the first retailer via the point of sale system.

In an embodiment, a second retailer is associated with the identification card.

It is, therefore, an advantage of the present invention to provide a system and a method for completing a transaction which may utilize an ID card and/or a POS system.

A further advantage of the present invention is to provide a system and a method for completing a transaction which may transfer a monetary value to and/or from a financial account associated with an ID card.

Another advantage of the present invention is to provide a system and a method for completing a transaction which may transfer a value of change received from a retail transaction to a financial account associated with an ID card.

And, another advantage of the present invention is to provide a system and a method for completing a transaction which may provide a server and/or a database for storing information relating to a financial account associated with an ID card.

Yet another advantage of the present invention is to provide a system and a method for completing a transaction which may access information relating to a financial account associated with an ID card via a website and/or a network.

A further advantage of the present invention is to provide a system and a method for completing a transaction which may prevent a retailer from distributing change from a retail transaction to a customer.

A still further advantage of the present invention is to provide a system and a method for completing a transaction which may contain a first balance and a second balance redeemable with a first retailer and/or with a second retailer.

Moreover, an advantage of the present invention is to provide a system and a method for completing a transaction which may reduce an amount of change accumulated by a customer from retail transactions.

And, another advantage of the present invention is to provide a system and a method for completing a transaction which may prevent a customer from losing change distributed by a retailer from a retail transaction.

Yet another advantage of the present invention is to provide a system and a method for completing a transaction which may allow a balance of a financial account associated with an ID card to be redeemed with a retailer.

Another advantage of the present invention is to provide a system and a method for completing a transaction which may limit an amount of change to be added to a financial account associated with an ID card.

And, another advantage of the present invention is to provide a system and a method for completing a transaction which may have a date of expiration for redeeming a balance of a financial account associated with an ID card.

Yet another advantage of the present invention is to provide a system and a method for completing a transaction which may have a personal identification number (hereinafter) associated with an ID card for accessing information relating to the ID card.

Another advantage of the present invention is to provide a system and a method for completing a transaction which may utilize an identification number and/or an identification code associated with a retailer.

And, another advantage of the present invention is to provide a system and a method for completing a transaction which may transfer an amount of money between a first retailer, a second retailer and/or a financial institute.

Yet another advantage of the present invention is to provide a system and a method for completing a transaction which may transfer a percentage of an amount of money to a retailer based on the amount of money transferred from the retailer to a financial account.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for completing a retail transaction in an embodiment of the present invention.

FIG. 2 illustrates a flowchart of steps for completing a retail transaction in an embodiment of the present invention.

FIG. 3 illustrates a flowchart of steps for completing a retail transaction in another embodiment of the present invention.

### DETAILED DESCRIPTION OF THE PRESENTLY PREFERRED EMBODIMENTS

The present invention generally relates to a system and a method for completing a transaction, such as, for example, a retail transaction. More specifically, the present invention generally relates to a system and a method for completing a transaction which utilizes a identification (hereinafter “ID”) card of a customer and a point of sale (hereinafter “POS”) system of a retailer. The customer may transfer and/or may tender an amount of money to the retailer to complete the retail transaction. The retailer may owe change to the customer from the retail transaction. The POS system -may identify a financial account associated with the ID card of the customer. The POS system may transfer a value of the change to the financial account associated with the ID card of the customer. As a result, the financial account associated with the ID card may have a balance with the retailer. The customer may utilize the balance of the financial account to perform and/or to complete a retail transaction with the retailer.

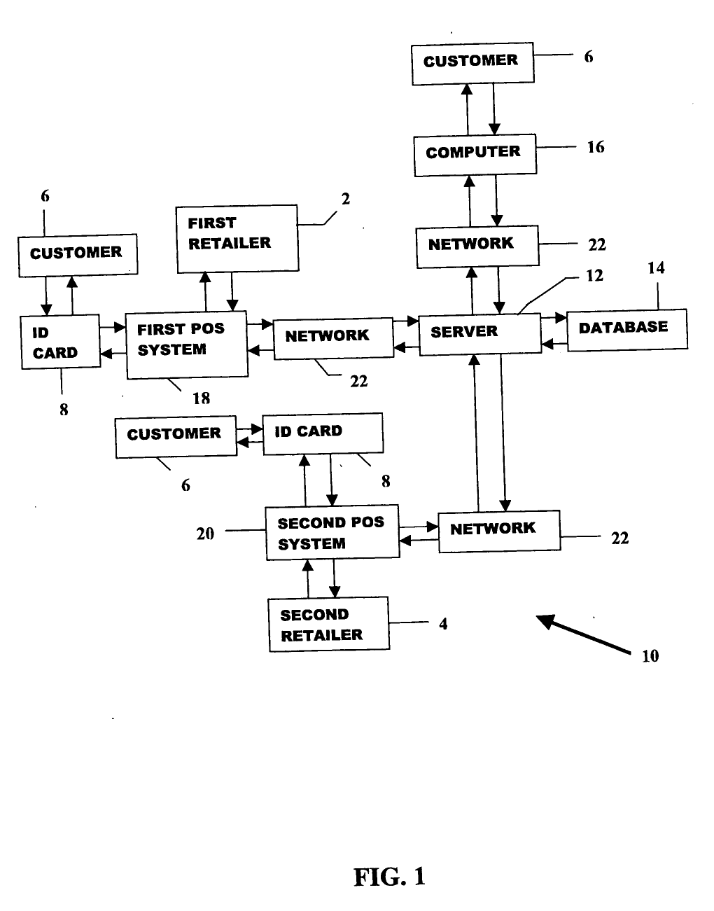

Referring now to the drawings wherein like numerals refer to like parts, FIG. 1 illustrates a system 10 having a server 12 and/or a database 14. The server 12 may be connected to and/or may be in communication with the database 14. The database 14 may be local or may be remote with respect to the server 12. The system 10 may have a computer 16, a first POS system 18 and/or a second POS system 20. The computer 16, the first POS system 18 and/or the second POS system 20 may be connected to the server 12 via the network 22. As a result, the computer 16, the first POS system 18 and/or the second POS system 20 may be connected to and/or may be in communication with the server 12 and/or the database 14 via the network 22. The first POS system 18 may be remote with respect to the second POS system 20. The computer 16, the first POS system 18 and/or the second POS system 20 may be remote with respect to the server 12 and/or the database 14.

The network 22 may be any type of computer network that may interconnect the server 12, the computer 16, the first POS system 18 and/or the second POS system 20. Of course, any number of servers, of computers, of first POS systems and/or of second POS systems may be connected to the network 22 and the invention should not be construed as limited as herein described. Further, the network 22 may be, for example, an internet, a local area network (hereinafter “LAN network”) and/or a wireless network. However, any network may be utilized that may be apparent to those skilled in the art. The present invention should not be deemed as limited to the embodiments of a specific network 22.

The computer 16 may be a personal computer, such as, for example, a stationary computer, a laptop computer, a handheld computer, a person digital assistant and/or the like. Further, the computer 16 may have access to the network 22. It should be understood that the computer 16 may be any computer which may access the network 22 as implemented by one having ordinary skill in the art. The present invention should not be deemed as limited to the embodiments of a specific computer 16.

The first POS system 18 and/or the second POS system 20 may be a device, such as, for example, an electronic funds transfer point of sale device. The first POS system 18 and/or the second POS system 20 may facilitate a sales transaction which may be debited to a financial account at the point of sale. The first POS system 18 and/or the second POS system 20 may operate with a standard protocol, such as, for example, a UnifiedPOS standard, a OPOS standard, a JavaPOS standard and/or the like. The present invention should not be deemed as limited to the embodiments of a specific device and/or a specific standard protocol for the first POS system 18 and/or the second POS system 20.

A first retailer 2 and/or a second retailer 4 may utilize the first POS system 18 and/or the second POS system 20, respectively, to access the server 12 and/or the database 14 via the network 22. The first retailer 2 and/or the second retailer 4 may be assigned, for example, an identification number, an identification code and/or the like. The identification number and/or the identification code may be stored in the database 14. The first retailer 2 and/or the second retailer 4 may be required to enter the identification number and/or the identification code into the first POS system 18 and/or the second POS system 20. The server 12 may identify the identification number and/or the identification code of the first retailer 2 and/or the second retailer 4 via the first POS system 18 and/or the second POS system 20, respectively. The server 12 may verify the identification number and/or the identification code of the first retailer 2 and/or the second retailer 4 with the database 14. As a result, the server 12 may authorize the first retailer 2 and/or the second retailer 4 to access the database 14. It should be understood that the first retailer 2 and/or the second retailer 4 may be assigned any identification means as implemented by one having ordinary skill in the art.

As illustrated in FIG. 1, the system 10 may be utilized by the first retailer 2, the second retailer 4 and/or a customer 6. An identification (hereinafter “ID”) card 8 may be assigned to and/or may belong to the customer 6. The ID card 8 may be associated with the first retailer and/or the second retailer 4. The ID card 8 may be associated and/or may be assigned to a first financial account and/or a second financial account with one or more financial institutions (not shown in the drawings). The financial institutions may be, for example, banks, depositories and/or the like. The present invention should not be deemed as limited to the embodiments of a specific financial institution.

The first financial account and/or the second financial account may relate to and/or may be associated with the first retailer 2 and/or the second retailer 4, respectively. The first financial account and/or the second financial account may have a first monetary balance and/or a second monetary balance, respectively. The first monetary balance and/or the second monetary balance may be utilized to purchase and/or may be redeemed for a good and/or a service from the first retailer 2 and/or the second retailer 4, respectively. The first monetary balance may be used to purchase and/or may be redeemed for a good and/or a service from the second retailer 4. Further, the second monetary balance may be used to purchase and/or may be redeemed for a good and/or a service from the first retailer 2.

The first retailer 2 and/or the second retailer 4 may limit an amount of the first monetary balance and/or the second monetary balance, respectively. The first monetary balance and/or the second monetary balance may have and/or may be assigned an expiration date by the first retailer 2 and/or the second retailer 4, respectively. The expiration date may be, for example, one year. The present invention should not be deemed as limited to the embodiments of a specific expiration date.

The ID card 8 may have an identification means (not shown in the drawings) which may be on a surface of the ID card 8 or within the ID card 8. The identification means of the ID card 8 may be, for example, a magnetic swipe stripe, a bar code, a radio frequency identification tag, a smart microchip and/or the like. The first POS system 18 and/or the second POS system 20 may have a card reader (not shown in the drawings) which may read, may identify and/or may detect the identification means of the ID card 8. The present invention should not be deemed as limited to the embodiments of a specific identification means of the ID card 8.

The first POS system 18 and/or the second system 20 may identify the ID card 18 and/or the first financial account and/or the second financial account associated with the ID card 18. As a result, the first POS system 18 and/or the second POS system 20 may identify and/or may access the first financial account and/or the second financial account associated with the ID card 8. Moreover, the first POS system 18 and/or the second POS system 20 may access, may increase and/or may decrease the first monetary balance and/or the second monetary balance of the first financial account and/or the second financial account.

As illustrated in FIG. 1, the ID card 8 of the customer 6 may be identified by the first POS system 18 and/or the second POS system 20 of the first retailer 2 and/or the second retailer 4, respectively. The first POS system 18 and/or the second POS system 20 of the first retailer 2 and/or the second retailer 4, respectively, may access the first monetary balance and/or the second monetary balance. The first monetary balance and/or the second monetary balance may be used to complete a retail transaction with the customer 6 and the first retailer 2 and/or the second retailer 4. The retail transaction may be, for example, a purchase of a good and/or a service by the customer 6 from the first retailer 2 and/or the second retailer 4. As a result, the first retailer 2 and/or the second retailer 4 may increase and/or may decrease the first monetary balance and/or the second monetary balance based on the retail transaction.

The first retailer 2 and/or the second retailer 4 may transfer an amount of money to the first financial account and/or the second financial account via the first POS system 18 and/or the second POS system 20. The first retailer 2 and/or the second retailer 4 may receive a percentage of the amount of money transferred to the first financial account and/or the second financial account. For example, the first retailer 2 may transfer eighty dollars to the first financial account for the retail transaction. As a result, the first financial institution may pay and/or may transfer one percent of the eighty dollars to the first retailer 2.

The first POS system 18 and/or the second POS system 20 may transmit, may transfer and/or may communicate information relating to the first monetary balance and/or the second monetary balance, respectively, to the server 12 via the network 22. The server 12 may process the information to identify the first financial account and/or the second financial account associated with the first monetary balance and/or the second monetary balance, respectively. The server 12 may update and/or may modify the first financial account and/or the second financial account based on the information received from the first POS system 18 and/or the second POS system 20, respectively. Further, the server 12 may store information relating to the first financial account and/or the second financial account in the database 14.

The customer 6, the first retailer 2 and/or the second retailer 4 may access and/or may view the information relating to the first financial account and/or the second financial account stored in the database 14. The customer 6 may use the computer 16 to access and/or to view a website (not shown in the drawings) stored in the database 14 via the server 12 and/or the network 22. The website may display the information relating to the first financial account and/or the second financial account. The first retailer 2 may use the first POS system 18 to access and/or to view the information relating to the first financial account of the customer 6 stored in the database 14 via the server 12 and/or the network 22. The second retailer 4 may use the second POS system 20 to access and/or to view the information relating to the first financial account of the customer 6 stored in the database 14 via the server 12 and/or the network 22. Alternatively, the first retailer 2 and/or the second retailer 4 may access the website stored in the database 14 to view the information relating to the first financial account and/or the second financial account, respectively.

A personal identification number (hereinafter “PIN”) may be associated with the ID card 8. The PIN associated with the ID card 8 may be stored in the database 14. The PIN may be a predetermined number or a number selected by the first retailer 2, the second retailer 4 and/or the customer 6. The PIN may be displayed on the ID card 8 and/or may be a number privately known to the customer 6. The customer 6, the first retailer 2 and/or the second retailer 4 may enter the PIN into the website to access the information relating to the first financial account and/or the second financial account. The server 12 may access the database 14 to verify the PIN of the ID card 8. The server 12 may authorize the website to display the information relating to the first financial account and/or the second financial account to the first retailer 2, the second retailer 4 and/or the customer 6. As a result, the information relating the first financial account and/or the second financial account may be displayed on the website and/or may be viewed from the computer 16, the first POS system 18 and/or the second POS system 20.

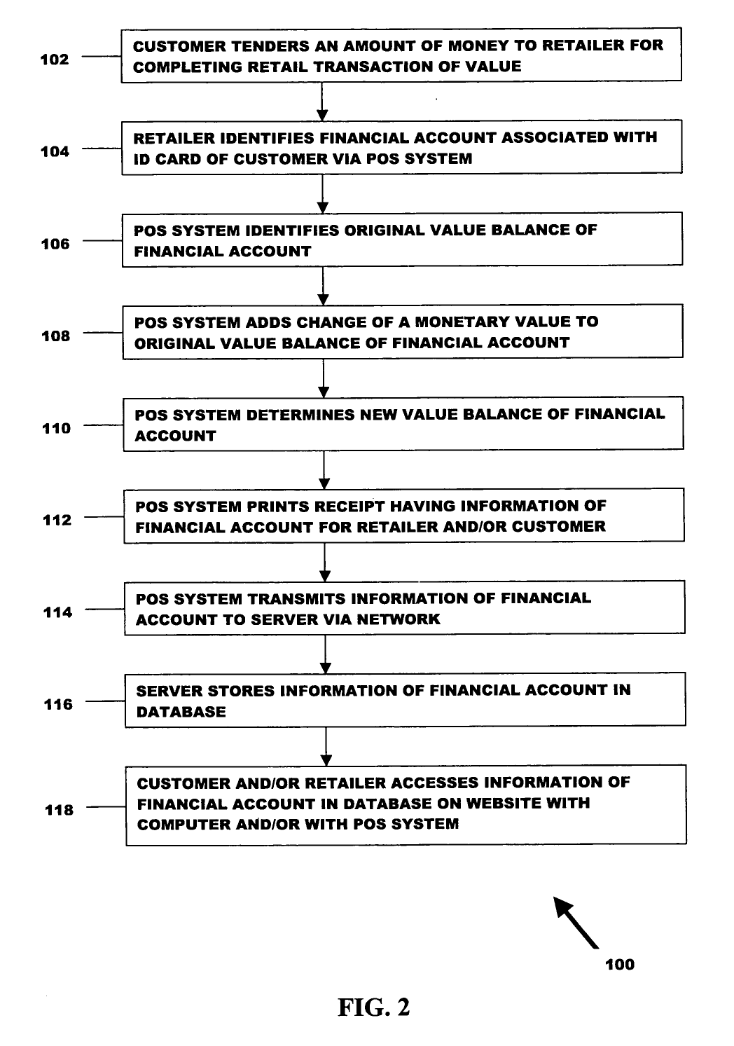

FIG. 2 illustrates a flowchart 100 of steps for completing a transaction in an embodiment of the present invention. The customer 6 may transfer and/or may tender an amount of money to the first retailer 2 for completing the retail transaction of a value as shown at step 102. The first retailer 2 may identify the first financial account associated with the ID card 8 with the first POS system 18 as shown at step 104. The card reader of the first POS system 18 may identify the ID card 8 with the identification means of the ID card 8. The first POS system 18 may identify an original value balance of the first financial account associated with the ID card 8 as shown at step 106. The original value balance of the first financial account may be stored in the database 14 and/or may be accessed by the first POS system 18 with the server 12 and/or the network 22.

The amount of money of the customer may be greater than the value of the retail transaction. As a result, the first retailer 2 may owe change of a monetary value to the customer 6 from the retail transaction. The first POS system 18 may add and/or may transfer the change from the retail transaction to the original value balance of the first financial account associated with the ID card 8 as shown at step 108. As a result, the first retailer 2 may transfer the change to the first financial account. The first retailer 2 may receive the percent of the change transferred to the first financial account. The first POS system 18 may determine a new value balance of the first financial account associated with the ID card 8 as shown at step 110. The new value balance may be calculated by adding the original value balance and the change from the retail transaction.

The first POS system 18 and/or the second POS system 20 may have a printer (not shown in the drawings) for producing and/or for printing a receipt for the retail transaction. The first POS system 18 may print the receipt which may contain the information relating to the first financial account for the customer 6 and/or the first retailer 2 as shown at step 112. The information relating to the first financial account may contain the original value balance, the change from the retail transaction and/or the new value balance of the first financial account.

The first POS system 18 may transmit, may transfer and/or may communicate the information relating to the first financial account to the server 12 over the network 22 as shown at step 114. The sever 12 may store the information relating to the first financial account in the database 14 as shown at step 116. The customer 6 and/or the first retailer 2 may access and/or may view the information relating to the first financial account on the website with the computer 16 and/or with the first POS system 18, respectively, as shown at step 118. The server 12 may require entry of the PIN associated with the ID card 8 prior to authorizing the customer 6 and/or the first retailer 2 to view the information stored in the database 14. Additionally, the server 12 may require entry of the identification number and/or the identification code of the first retailer 2 to view the information stored in the database 14. Alternatively, the first retailer 2 may access and/or may view the website stored in the database 14 via the server 12 and/or the network 22.

For example, the customer 6 may transfer and/or may tender two dollars to the first retailer 2 to complete a retail transaction valued at one dollar and eighty cents. As a result, the first retailer 2 may owe change in the amount of twenty cents to the customer 6 for the retail transaction. The first financial account may have an original value balance of ten dollars. The first POS system 18 of the first retailer 2 may identify the first financial account associated with the ID card 8 of the customer 6. The first POS system 18 may identify the original value balance of ten dollars for the first financial account via the server 12, the database 14 and/or the network 22.

The first POS system 18 may add the sales change value of twenty cents to the original value balance of ten dollars. As a result, the first POS system 18 may determine the new value balance of ten dollars and twenty cents for the first financial account. The first retailer 2 may receive the percentage of the sales change value transferred to the first financial account. The first POS system 18 may print the receipt with may display the original value balance of ten dollars and/or the sales change value of twenty cents and/or the new value balance of ten dollars and twenty cents. The customer 6 may redeem and/or may add to the new value balance of the first financial account associated with the ID card 8. The customer 6 may utilize the ID card 8 to redeem the new value balance of the first financial account with the first retailer 2 and/or the second retailer 4.

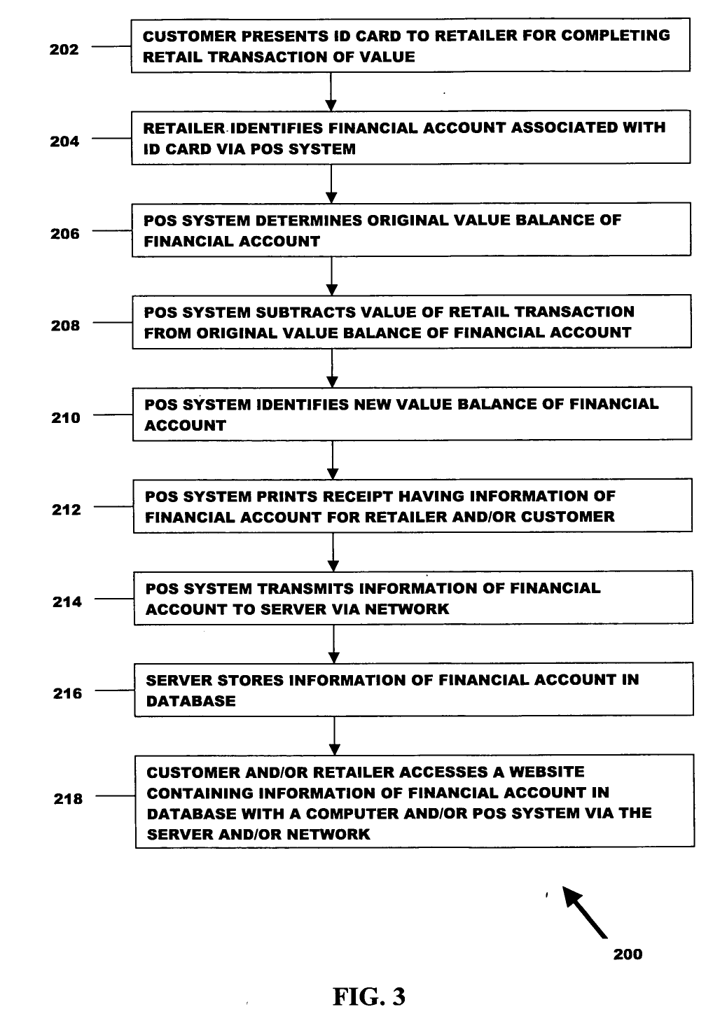

FIG. 3 illustrates a flowchart 200 of steps for completing a retail transaction in another embodiment of the present invention. The customer 6 may present the ID card 8 to the first retailer 2 for completing the retail transaction of a value as shown at step 202. For example, the value of the transaction may be four dollars. The retailer 2 may identify the first financial account associated with the ID card 8 with the first POS system 18, as shown at step 204. The first POS system 18 may identify the original value balance of the first financial account stored in the database 14 with the server 12 and/or the network 22 as shown at step 206. For example, the first financial account may have an original value balance of five dollars.

The first POS system 18 may subtract the value of the retail transaction from the original value balance of the first financial account as shown at step 208. The first financial account may transfer a monetary value corresponding the to the value of the retail transaction to the first retailer 2. The first retailer 2 may receive the monetary value from the first financial account within a period of time between for example, forty-eight hours to seventy-two hours. The first POS system 18 may determine a new value balance of the first financial account as shown at step 210. The new value balance may be a difference between the original value balance and the value of the retail transaction. For example, the new value balance of one dollar may be the difference between the original value of five dollars and the value of the retail transaction of four dollars.

The first POS system 18 may print the receipt having the information of the first financial account for the first retailer 2 and/or the customer 6 as shown at step 212. The information may contain the original value balance and/or the value of the retail transaction and/or the new value balance. The first POS system 18 may transmit, may transfer and/or may communicate the information relating to the first financial account to the server 12 with the network 22 as shown at step 214. The server 12 may store the information relating to the first financial account in the database 14 as shown at step 216. The customer 6 and/or the first retailer 2 may access and/or may view the information relating to the first financial account on the website with the computer 16 and/or with the first POS system 18, respectively, as shown at step 218. The server 12 may require entry of the PIN associated with the ID card 8 prior to authorizing the customer 6 and/or the first retailer 2 to view the information stored in the database 14. Alternatively, the first retailer 2 may access and/or may view the website stored in the database 14 via the server 12 and/or the network 22.

The value of the retail transaction may be greater than the original value balance of the first financial account associated with the ID card 8. The customer 6 may transfer and/or may tender an amount of money to the first retailer 2 for the difference between the original value balance and the value of the retail transaction. For example, the value of the retail transaction may be ten dollars and the original value balance may be nine dollars. The customer 6 may transfer and/or may tender one dollar to the first retailer 2 for completing the retail transaction. As a result, the new value balance of the first financial account may be zero.

The system 10 may complete a transaction via the ID card 8 of the customer 6 and the POS system 18 of the first retailer 2. The customer 6 may transfer and/or may tender the amount of money to the first retailer 2 to complete the retail transaction. The first retailer 2 may owe change to the customer 6 for the retail transaction. The first POS system 18 may identify a financial account associated with the ID card 8 of the customer 6. The first POS system 18 may transfer a value of change to the financial account associated with the ID card 8 of the customer 6. The first retailer 2 may transfer the change to the financial account associated with the ID card 8. As a result, the financial account associated with the ID card 8 may have a balance with the first retailer 2. The customer 6 may use the balance of the financial account to perform and/or to complete another retail transaction with the first retailer 2 and/or the second retailer 4.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for completing a transaction between a customer and a first retailer wherein the transaction has a first monetary value, the system comprising:
an identification card assigned to the customer wherein an amount of money is tendered to the first retailer by the customer wherein the amount of money is greater than the first monetary value;
a first financial account associated with the identification card wherein the first financial account has a balance of a second monetary value;
a database for storing information based on the balance of the first financial account;
a server connected to the database wherein the server accesses the balance of the first financial account and further wherein the server stores the information based on the balance of the first financial account in the database; and
a first point of sale system remotely connected to the server via a network wherein the first point of sale system is local with respect to the customer wherein the identification card is identified by the first point of sale system wherein the first point of sale system accesses the information stored in the database to determine the balance of the first financial account wherein the first point of sale system electronically transfers a third monetary value to the balance of the first financial account via the network and further wherein the third monetary value is a difference between the amount of money and the first monetary value.

2. The system of claim 1 further comprising:
a code associated with the first retailer.

3. The system of claim 1 further comprising:
a code associated with the identification card.

4. The system of claim 1 further comprising:
a second financial account associated with the identification card.

5. The system of claim 1 further comprising:
a second retailer associated with the identification card.

6. The system of claim 1 further comprising:
a second retailer redeems the balance of the first financial account.

7. The system of claim 1 wherein the balance of the first financial account is zero.

8. The system of claim 1 wherein the balance of the first financial account is redeemable with the first retailer via the first point of sale system.

9. A method for completing a transaction of a first monetary value between a customer and a retailer wherein the customer tenders an amount of money to the retailer for completing the transaction wherein the amount of money is greater than the first monetary value, the method comprising the steps of:
providing an identification card to the customer wherein the identification card is associated with a financial account having a balance of a second monetary value;
storing information in a database wherein the information is based on the balance of the financial account wherein the database is remote with respect to the customer;
providing a point of sale system of the retailer wherein the point of sale system is connected to the database via a network wherein the point of sale system is remote with respect to the database;
electronically accessing the information in the database via a point of sale system of the retailer wherein the point of sale system determines the balance of the financial account via the information stored in the database; and
electronically transferring a third monetary value to the balance of the financial account via the point of sale system and the network wherein the third monetary value is a difference between the amount of money and the first monetary value.

10. The method of claim 9 further comprising the step of:
printing a receipt displaying the first monetary value, the second monetary value, the third monetary value, the amount of money or the balance of the financial account.

11. The method of claim 9 further comprising the step of:
providing a website for displaying the information stored in the database.

12. The method of claim 9 further comprising the step of:
redeeming the balance of the financial account.

13. The method of claim 9 wherein the balance of the financial account is zero.

14. The method of claim 9 further comprising the step of:
assigning an identification code to the retailer, the customer or the identification card.

15. The method of claim 9 further comprising the step of:
transferring a fourth monetary value from the financial account to the retailer

16. A method for completing a transaction of a first monetary value between a first retailer and a customer wherein the customer tenders an amount of money to the first retailer wherein the amount of money is greater than the first monetary value, the method comprising of the steps of:
providing an identification card to the customer wherein the identification card is associated with a first financial account wherein the first financial account has a balance of a second monetary value wherein the first financial account is associated with the first retailer;
storing information in a database wherein the information is based on the balance of the first financial account;
providing a server for accessing the information stored in the database wherein the server is connected to the database via a network;
identifying the first financial account with a point of sale system of the first retailer wherein the point of sale system is connected to the server via the network wherein the point of sale system is remote with respect to the server and further wherein the point of sale system determines the balance of the first financial account from the information stored in the database; and
electronically transferring a third monetary value to the balance of the first financial account via the point of sale system wherein the third monetary value is a difference between the first monetary value and the amount of money.

17. The method of claim 16 wherein the balance of the first financial account is zero.

18. The method of claim 16 further comprising the step of:
accessing a second financial account associated with the identification card.

19. The method of claim 16 further comprising the step of:
assigning an identification code to the first retailer, the customer or the identification card.

20. The method of claim 16 further comprising the step of:
redeeming the balance of the first financial account.
